(19) United States
(12) Patent Application Publication
(10) Pub. No.: US 2016/0363731 A1
(43) Pub. Date: Dec. 15, 2016

(54) DEVICE FOR TRANSITIONING FROM TRUNK CABLE TO JUMPER CABLE

(71) Applicant: CommScope Technologies LLC, Hickory, NC (US)

(72) Inventor: Chi Ming Wang, Chicago, IL (US)

(21) Appl. No.: 15/176,985

(22) Filed: Jun. 8, 2016

Related U.S. Application Data
(60) Provisional application No. 62/172,976, filed on Jun. 9, 2015.

(51) Int. Cl. G02B 6/38; H01R 13/504; H01R 13/512; H01R 13/52

(52) U.S. Cl. CPC G02B 6/3817; H01R 13/5205; H01R 13/504; H01R 13/512; G02B 6/3887

(57) ABSTRACT

An assembly includes: a housing comprising first and second mating pieces, at least one of the first and second mating pieces including at least one connector, each of the first and second mating pieces including a respective compressing feature, wherein mating of the first and second mating pieces forms a compressing aperture between the compressing features of the first and second mating pieces; and a cable comprising a plurality of signal- and/or power-carrying members surrounded by an outer covering, the signal and/or power carrying members connected with the connector. The cable resides in the compressing aperture, with the compressing features securing the cable outer jacket and forming a seal therewith.

### RELATED APPLICATION

The present application claims priority from and the benefit of U.S. Provisional Patent Application No. 62/172,976, filed Jun. 9, 2015, the disclosure of which is hereby incorporated herein by reference in its entirety.

### FIELD OF THE INVENTION

The invention relates generally to power and signal distribution, and more particularly to distribution from hybrid cables.

### BACKGROUND

Latest developments in technology for delivering power and data in wireless infrastructure use hybrid cables, wherein the term “hybrid cable” refers to a cable that includes both power conductors and one or more fiber optic cords or cables. An exemplary hybrid cable is the HFF cable, available from CommScope, Inc. (Joliet, Ill.). Unlike RF-based systems, a single hybrid trunk cable can be used to power multiple sectors, thereby eliminating multiple runs of RF cable. However, in order to use a single hybrid trunk cable, at some point the trunk cable must transition to jumper cables. Typically, these are distributed inside an enclosure that transitions the trunk conductor gauge to the jumper conductor gauge and connects the optical fibers in the trunk to the optical fibers in the jumper cables. Currently, transitions are achieved by making connections inside the enclosure, requiring it to be opened, cables to be fed/mated to the enclosure, and power and fiber connections to be made, all in the field (e.g., on the top of cell sites near a remote radio unit (RRU)). This practice can create many issues for installers, including time, safety, connection errors (such as loose power connections and/or poor fiber cleaning), and more opportunity for connector damage.

### SUMMARY OF THE INVENTION

As a first aspect, embodiments of the invention are directed to an assembly, comprising: a housing comprising first and second mating pieces, at least one of the first and second mating pieces including at least one connector, each of the first and second mating pieces including a respective compressing feature, wherein mating of the first and second mating pieces forms a compressing aperture between the compressing features of the first and second mating pieces; and a cable comprising a plurality of signal- and/or power-carrying members surrounded by an outer covering, the signal and/or power carrying members connected with the connector. The cable resides in the compressing aperture, with the compressing features securing the cable outer covering and forming a seal therewith.

As a second aspect, embodiments of the invention are directed to an assembly, comprising: a housing comprising first and second mating pieces, at least one of the first and second mating pieces including at least one connector, each of the first and second mating pieces including a respective compressing feature with an overlying grommet layer, wherein mating of the first and second mating pieces forms a compressing aperture between the grommet layers of the first and second mating pieces; and a cable comprising a plurality of signal- and/or power-carrying members surrounded by an outer covering, the signal and/or power carrying members connected with the connector. The cable resides in the compressing aperture, with the grommet layers securing the cable outer covering and forming a seal therewith.

As a third aspect, embodiments of the invention are directed to a method of forming an assembly, comprising the steps of: providing first and second mating pieces, at least one of the first and second mating pieces including at least one connector, each of the first and second mating pieces including a respective compressing feature; providing a cable comprising a plurality of signal- and/or power-carrying members surrounded by an outer covering, the signal and/or power carrying members connected with the connector; and mating the first and second mating pieces such that the cable resides in a compressing aperture formed by the compressing features, with the compressing features securing the cable outer covering and forming a seal therewith.

### BRIEF DESCRIPTION OF THE FIGURES

FIG. 1 is an exploded perspective view of an exemplary enclosure according to embodiments of the present invention.

FIG. 2 is an exploded side view of the enclosure of FIG. 1.

FIG. 3 is a partially exploded view of the enclosure of FIG. 1 with a hybrid cable in place for attachment.

### DETAILED DESCRIPTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Unless otherwise defined, all technical and scientific terms that are used in this disclosure have the same meaning as commonly understood by one of ordinary skill in the art to which this invention belongs. The terminology used in the below description is for the purpose of describing particular embodiments only and is not intended to be limiting of the invention. As used in this disclosure, the singular forms “a”, “an” and “the” are intended to include the plural forms as well, unless the context clearly indicates otherwise. It will also be understood that when an element (e.g., an assembly, a housing, a cable, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

In co-assigned and co-pending U.S. patent application Ser. No. 14/448,269, filed Jul. 31, 2014, and Ser. No. 15/071,620, filed Mar. 16, 2016, the disclosure of each of which is hereby incorporated herein in its entirety, devices are described that provide a solution to some of the issues described above. The devices discussed therein comprise an enclosure having mixed media connectors in one or more walls to receive jumper cables. A hybrid fiber-power trunk cable is routed to the bottom wall of the enclosure, then is routed within the enclosure to the mixed media connectors. The trunk cable is either attached to the enclosure via a trunk cable connector, which is then connected with the mixed media connectors, or is routed through a cable gland or epoxy nozzle in the bottom wall of the enclosure and connected with the mixed media connectors.

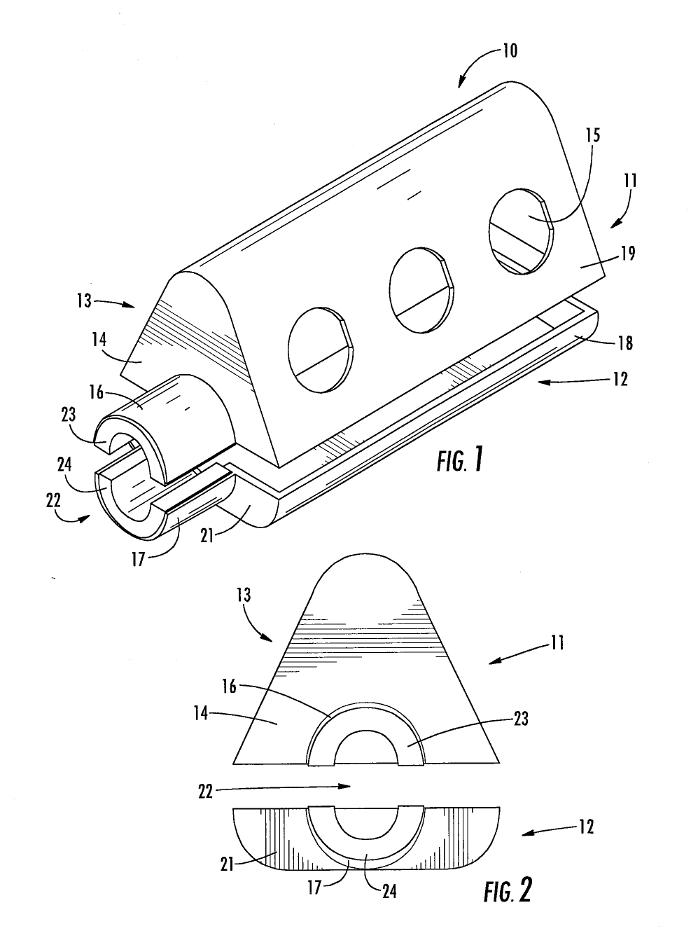

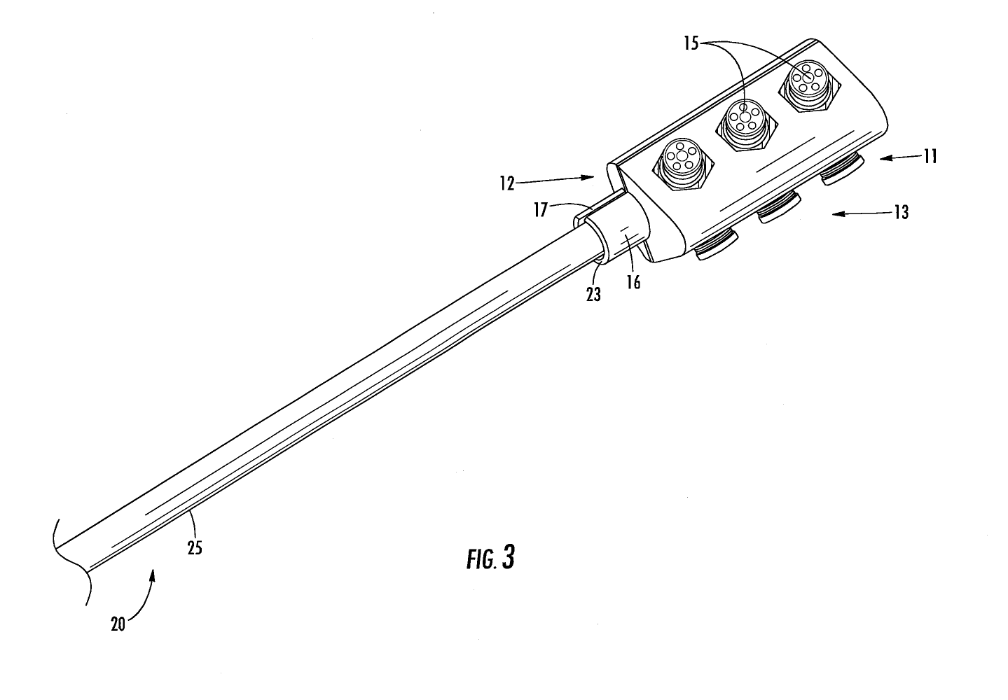

Embodiments of the invention are directed to techniques for securing a cable (such as the hybrid fiber-power cable described above) to an enclosure that may be simpler or easier to perform. Referring now the figures, an enclosure of generally triangular cross-section, designated broadly, at 10, is shown in FIGS. 1-3. The enclosure 10 comprises two mating pieces 11, 12 that fit together to form a housing 13. The top piece 11 is generally triangular in cross-section; the bottom piece 12 is generally flat with raised side walls 18 that meet side walls 19 of the top piece 11 when the top and bottom pieces 11, 12 are mated. Connectors 15 are mounted on the side walls 19 of the top piece 11 (although in some embodiments a single connector may be mounted in the side walls). In the illustrated embodiment, the connectors 15 are multi-media connectors that provide termination sites for both power conductors and optical fibers, although other types of connectors, such as separate power and/or optical connectors or solely power or optical connectors, may be mounted on the housing 13. The housing 13 is shown as being generally triangular in profile, but may alternatively take another shape (square, rectangular, circular, ovoid, or the like).

The housing 13 also includes a compressing aperture 22 that is formed by a semicircular flange 16 extending from an end wall 14 of the top piece 11 and a semicircular flange 17 extending from an end wall 21 in the bottom piece 12. Each of the flanges 16, 17 is lined with a respective grommet layer 23, 24 on its inner surface. These overlying grommet layers 23, 24 may be formed of material typically employed for grommets, such as neoprene, vitron, and buna-N rubbers.

A cable 20 extends through the aperture 22. The cable 20 includes an exterior jacket 25 that is typically formed of an elastomeric or polymeric material. Within the jacket 25 are interior components (e.g., one or more signal- or power-carrying optical fibers or conductors) that are to be routed into the interior of the housing 13, where they are connected to the connectors 15. Those of skill in this art will appreciate that the cable 20 may be any cable with an outer covering, including hybrid fiber/power cables as discussed above, coaxial cables, fiber optic cables, and the like.

The housing 13 can be assembled by first connecting the conductors and/or optical fibers to the connectors 15 in the top piece 11 of the housing 13. The top and bottom pieces 11, 12 are then aligned, with the cable 20 positioned between the flanges 16, 17 of the top and bottom pieces 11, 12. The pieces 11, 12 are then mated to form the housing 13. Securing of the two pieces 11, 12 can be achieved in any number of ways known to those of skill in this art, including screws, bolts, welding, adhesives, and the like. Once the top and bottom pieces 11, 12 are assembled to form the housing 13, the grommet layers 23, 24 of the flanges 16, 17 compress the jacket 25. The presence of the grommet layers 23, 24 in compressive contact with the cable jacket 25 can create a watertight seal at the junction between the cable 20 and the housing 13. Additionally, the compression of the cable jacket 25 can resist movement of the cable 20 relative to the housing 13 and thereby secure the cable 20 in place.

Those of skill in this art will appreciate that, although semicircular flanges 16, 17 and grommet layers 23, 24 are illustrated herein, features of other shapes that can compress the cable 20 as the housing 13 is assembled may also be suitable for use (for example, the flange 16 may be arcuate and/or describe more than a semicircle, and the flange 17 may correspondingly be arcuate and/or describe less than a semicircle). In some embodiments, the grommet layers 23, 24 may be integrated with gaskets or other sealing structures that seal the mating edges of the pieces 11, 12 as they are assembled into the housing 13. It will also be appreciated that grommet layers 23, 24 may be supplied in different thicknesses to accommodate cables of different sizes with the same housing 13.

It may also be appreciated that, in some embodiments, the grommet layers may be omitted entirely, particularly if the jacket 25 of the cable 20 is sufficiently compressive to create a seal with the housing 13. In further embodiments, teeth, knurls, texturing, and similar grip-enhancing features that “dig into” the cable jacket 25 may be included to improve securing of the cable 20; such features may be included in the grommet layers 23, 24 or in the flanges 16, 17 if no grommet layers are included.

Moreover, in some instances it may be desirable to integrate other assembly steps (for example, establishment of a ground drain path or termination of power conductors to the connectors 15) with the compressive securing of the cable 20.

Other potential advantages are discussed in co-assigned and co-pending U.S. patent application Ser. Nos. 14/448,269 and 15/071,620, supra.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An assembly, comprising:
a housing comprising first and second mating pieces, at least one of the first and second mating pieces including at least one connector, each of the first and second mating pieces including a respective compressing feature, wherein mating of the first and second mating pieces forms a compressing aperture between the compressing features of the first and second mating pieces; and
a cable comprising at least one signal- and/or power-carrying member surrounded by an outer covering, the signal and/or power carrying member connected with the connector;
wherein the cable resides in the compressing aperture, with the compressing features securing the cable outer covering and forming a seal therewith.

2. The assembly defined in claim 1, wherein the compressing features of the first and second mating pieces comprise projecting arcuate flanges.

3. The assembly defined in claim 2, wherein a grommet layer overlies each of the projecting flanges of the first and second mating pieces.

4. The assembly defined in claim 3, wherein at least one of the grommet layers is integrated with a gasket that provides a seal between mating edges of the first and second mating pieces.

5. The assembly defined in claim 1, wherein the compressing features comprises grip-enhancing features.

6. The assembly defined in claim 1, wherein the cable is a hybrid power/fiber cable.

7. The assembly defined in claim 4, wherein the connector comprises a multi-media connector.

8. The assembly defined in claim 1, wherein mating of the first and second pieces with the cable induces the establishment of a ground drain path.

9. An assembly, comprising:
a housing comprising first and second mating pieces, at least one of the first and second mating pieces including at least one connector, each of the first and second mating pieces including a respective compressing feature with an overlying grommet layer, wherein mating of the first and second mating pieces forms a compressing aperture between the grommet layers of the first and second mating pieces; and
a cable comprising at least one signal- and/or power-carrying member surrounded by an outer covering, the signal and/or power carrying member connected with the connector;
wherein the cable resides in the compressing aperture, with the grommet layers securing the cable outer covering and forming a seal therewith.

10. The assembly defined in claim 9, wherein at least one of the grommet layers is integrated with a gasket that provides a seal between mating edges of the first and second mating pieces.

11. The assembly defined in claim 9, wherein the compressing features comprises grip-enhancing features.

12. The assembly defined in claim 9, wherein the cable is a hybrid power/fiber cable.

13. The assembly defined in claim 12, wherein the connector comprises a multi-media connector.

14. The assembly defined in claim 9, wherein mating of the first and second pieces with the cable induces the establishment of a ground drain path.

15. A method of forming an assembly, comprising the steps of:
providing first and second mating pieces, at least one of the first and second mating pieces including at least one connector, each of the first and second mating pieces including a respective compressing feature;
providing a cable comprising at least one signal- and/or power-carrying member surrounded by an outer covering, the signal and/or power carrying member connected with the connector;
mating the first and second mating pieces such that the cable resides in a compressing aperture formed by the compressing features, with the compressing features securing the cable outer covering and forming a seal therewith.

16. The method defined in claim 15, further comprising the step of connecting the signal and/or power-carrying member with the connector prior to the mating step.

17. The method defined in claim 15, wherein the compressing features of the first and second mating pieces comprise projecting flanges.

18. The method defined in claim 17, wherein a grommet layer overlies each of the projecting flanges of the first and second mating pieces.

19. The method defined in claim 18, wherein at least one of the grommet layers is integrated with a gasket that provides a seal between mating edges of the first and second mating pieces.

20. The method defined in claim 15, wherein the cable is a hybrid power/fiber cable.
